(19) United States
(12) Patent Application Publication
(10) Pub. No.: US 2024/0090361 A1
(43) Pub. Date: Mar. 21, 2024

(54) SYSTEM AND METHOD FOR DETERMINING SOIL COMPACTION LAYER LOCATION DURING AGRICULTURAL IMPLEMENT OPERATION

(71) Applicant: CNH Industrial America LLC, New Holland, PA (US)

(72) Inventor: Brittany Schroeder, Bunker Hill, IN (US)

(21) Appl. No.: 17/946,317

(22) Filed: Sep. 16, 2022

(51) Int. Cl. A01B 79/00; A01B 63/00; A01B 63/111

(52) U.S. Cl. CPC A01B 79/005; A01B 63/002; A01B 63/111

(57) ABSTRACT

An agricultural implement includes a force sensor configured to generate data indicative of the force being applied to a ground-penetrating tool of the implement by the soil. A computing system is configured to analyze data generated by a soil sensor to determine the position of a bottom surface of the compaction layer. Furthermore, the computing system is configured to control the operation of an actuator such that a tip of the ground-penetrating tool is positioned at an initial penetration depth below the determined bottom surface of the compaction layer. Additionally, the computing system is configured to determine the direction of the force being applied to the ground-penetrating tool based on the data generated by the force sensor. Moreover, the computing system is configured to calibrate the soil sensor based on the determined direction of the force.

### FIELD OF THE INVENTION

The present disclosure generally relates to agricultural implements and, more particularly, to systems and methods for determining soil compaction layer location during operation of an agricultural implement.

### BACKGROUND OF THE INVENTION

It is well known that, to attain the best agricultural performance from a piece of land, a farmer must cultivate the soil, typically through a tillage operation. Common tillage operations include plowing, harrowing, and sub-soiling. Modern farmers perform these tillage operations by pulling a tillage implement behind an agricultural work vehicle, such as a tractor. Depending on the crop selection and the soil conditions, a farmer may need to perform several tillage operations at different times over a crop cycle to properly cultivate the land to suit the crop choice.

When performing certain tillage operations, it is generally desirable to break up any layers of subsurface soil that have been compacted (e.g., due to vehicle traffic, ponding, and/or the like). As such, during such tillage operations, shanks or other ground-penetrating tools supported on the tillage implement are pulled through the soil to fracture the compaction layer. However, the depth of the compaction layer may vary throughout the field. In this respect, systems have been developed that allow compaction layers to be detected and the penetration depths of the shanks or other tools to be adjusted accordingly. While such systems work well, further improvements are needed.

Accordingly, an improved system and method for determining soil compaction layer location during agricultural implement operation would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to an agricultural implement. The agricultural implement, in turn, includes a frame, a ground-penetrating tool configured to penetrate soil within a field to a penetration depth, and an actuator configured to adjust the penetration depth of the ground-penetrating tool. Furthermore, the agricultural implement includes a force sensor configured to generate data indicative of a force being applied to the ground-penetrating tool by the soil. Additionally, the agricultural implement includes a soil sensor configured to generate data indicative of a location of a compaction layer within the field and a computing system communicatively coupled to the force sensor and the soil sensor. In this respect, the computing system is configured to analyze the data generated by the soil sensor to determine a position of the bottom surface of the compaction layer. Moreover, the computing system is configured to control an operation of the actuator such that a tip of the ground-penetrating tool is positioned at an initial penetration depth below the determined bottom surface of the compaction layer. In addition, the computing system is configured to determine a direction of the force being applied to the ground-penetrating tool based on the data generated by the force sensor and calibrate the soil sensor based on the determined direction of the force.

In another aspect, the present subject matter is directed to a system for determining soil compaction layer location during an operation of an agricultural implement. The system includes a ground-penetrating tool configured to penetrate soil within a field to a penetration depth and an actuator configured to adjust the penetration depth of the ground-penetrating tool. Furthermore, the system includes a force sensor configured to generate data indicative of a force being applied to the ground-penetrating tool by the soil. Additionally, the system includes a soil sensor configured to generate data indicative of a location of a compaction layer within the field and a computing system communicatively coupled to the force sensor and the soil sensor. In this respect, the computing system is configured to analyze the data generated by the soil sensor to determine a position of the bottom surface of the compaction layer. Moreover, the computing system is configured to control an operation of the actuator such that a tip of the ground-penetrating tool is positioned at an initial penetration depth below the determined bottom surface of the compaction layer. In addition, the computing system is configured to determine a direction of the force being applied to the ground-penetrating tool based on the data generated by the force sensor and calibrate the soil sensor based on the determined direction of the force.

In a further aspect, the present subject matter is directed to a method for determining soil compaction layer location during an operation of an agricultural implement. The agricultural implement, in turn, includes a ground-penetrating tool configured to penetrate soil within a field to a penetration depth and an actuator configured to adjust the penetration depth of the ground-penetrating tool. The method includes receiving, with a computing system, soil sensor data indicative of a location of a compaction layer within the field from a soil sensor. Furthermore, the method includes analyzing, with the computing system, the received soil sensor data to determine a position of the bottom surface of the compaction layer. Additionally, the method includes controlling, with the computing system, an operation of the actuator such that a tip of the ground-penetrating tool is positioned at an initial penetration depth below the determined bottom surface of the compaction layer. Moreover, the method includes receiving, with the computing system, force sensor data indicative of a force being applied to the ground-penetrating tool by the soil. In addition, the method includes determining, with the computing system, a direction of the force being applied to the ground-penetrating tool based on the received force sensor data. Furthermore, the method includes calibrating, with the computing system, the soil sensor based on the determined direction of the force.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a work vehicle towing an agricultural implement in accordance with aspects of the present subject matter;

FIG. 2 illustrates a side view of one embodiment of a shank of an agricultural implement in accordance with aspects of the present subject matter;

FIG. 3 illustrates a schematic view of one embodiment of a system for determining soil compaction layer location during agricultural implement operation in accordance with aspects of the present subject matter;

FIG. 4 illustrates a flow diagram providing one embodiment of control logic for determining soil compaction layer location during agricultural implement operation in accordance with aspects of the present subject matter; and

FIG. 5 illustrates a flow diagram of one embodiment of a method for determining soil compaction layer location during agricultural implement operation in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to a system and method for determining soil compaction layer location during agricultural implement operation. Specifically, the system includes one or more force sensors, with each force sensor being configured to generate data indicative of the force being applied to a ground-penetrating tool (e.g., a shank) of the implement by the soil within the field. Additionally, the agricultural implement includes a soil sensor configured to generate data indicative of the location of the compaction layer within the field. The compaction layer, in turn, is a layer of compressed or compacted soil located below the surface of the field that may be caused by vehicle traffic, ponding, and/or the like. For example, in one embodiment, the soil sensor may include a ground-penetrating radar (GPR) sensing device and an electromagnetic induction (EMI) sensing device. In another embodiment, the soil sensor could be any ground-penetrating sensing system, such as a radar, sonar, or inductance sensor.

In several embodiments, a computing system of the disclosed system is configured to calibrate the soil sensor to allow for accurate determinations of the location of the compaction layer during operation of the agricultural implement. More specifically, the computing system is configured to analyze the data generated by the soil sensor to determine the position of the bottom surface of the compaction layer. Furthermore, the computing system is configured to control the operation of one or more actuators of the implement such that the tip(s) of the ground-penetrating tool(s) is positioned below the bottom surface of the compaction layer as determined based on the soil sensor data. Moreover, the computing system is configured to determine the direction(s) of the force(s) being applied to the ground-penetrating tool(s) based on the data generated by the force sensor(s). Thereafter, the computing system is configured to calibrate the soil sensor based on the determined direction(s) of the force(s). For example, in some embodiments, when the direction(s) of the force(s) being applied to the ground-penetrating tool(s) is downward, the computing system may determine that the soil sensor is properly calibrated. Conversely, when the direction(s) of the force(s) being applied to the ground-penetrating tool(s) is upward, the computing system may determine that the soil sensor is improperly calibrated. In such instances, the computing system may change the analysis technique being used to analyze the soil sensor data and/or control the actuator(s) to adjust the penetration depths(s) of the ground-penetrating tool(s).

Using the direction(s) of the force(s) being applied to the ground-penetrating tool(s) to calibrate the soil sensor improves the accuracy of the determinations of the compaction layer location. More specifically, non-contact-based sensors, such as GPR and EMI sensors, must generally be calibrated based on certain characteristics or conditions of the field (e.g., soil moisture, salinity, texture, etc.) to provide accurate determinations of compaction layer location. However, such characteristics may vary throughout the field. Moreover, field maps of such characteristics may be inaccurate, such as due to changes in field conditions after mapping and/or GPS drift. In this respect, as described above, the disclosed system and method calibrate the soil sensor using the direction(s) of the force(s) being applied to the ground-penetrating tool(s), which is unaffected by the changes in the conditions of the field. Thus, the disclosed system and method provide more accurate determinations of compaction layer location, thereby allowing for improved control of the agricultural implement and the increased quality of agricultural operation being performed by the implement.

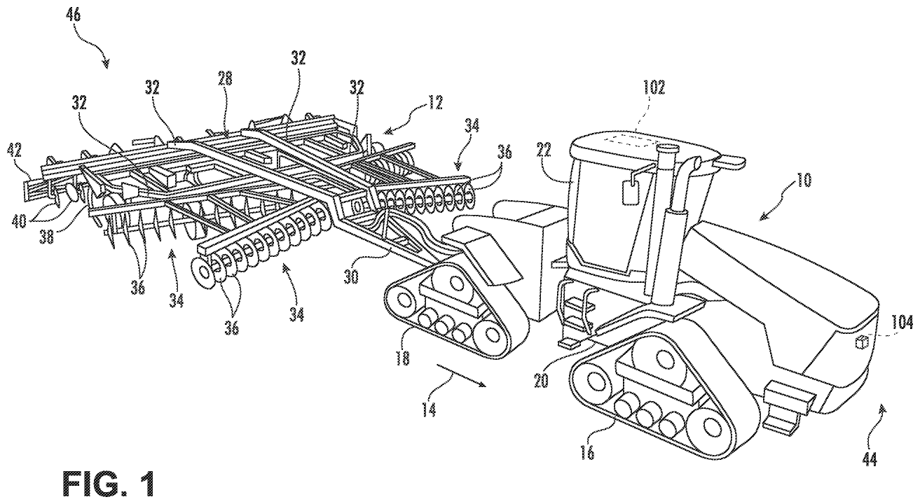

Referring now to the drawings, FIG. 1 illustrates a perspective view of one embodiment of a work vehicle 10 and an associated agricultural implement 12 in accordance with aspects of the present subject matter. In general, the work vehicle 10 may be configured to tow the agricultural implement 12 across a field in a direction of travel (indicated by arrow 14). As such, in one embodiment, the work vehicle 10 may be configured as an agricultural tractor and the agricultural implement 12 may be configured as a tillage implement. However, in other embodiments, the work vehicle 10 may be configured as any other suitable work vehicle, such as an agricultural harvester, a self-propelled sprayer, etc. Similarly, the implement 12 may be configured as any other suitable agricultural implement, such as a seeder, planter, nutrient applicator, etc.

As shown, the work vehicle 10 includes a pair of front track assemblies 16, a pair or rear track assemblies 18, and a frame or chassis 20 coupled to and supported by the track assemblies 16, 18. An operator's cab 22 may be supported by a portion of the chassis 20 and may house various input devices (e.g., a user interface) for permitting an operator to control the operation of one or more components of the work vehicle 10 and/or one or more components of the agricultural implement 12.

Additionally, as shown in FIG. 1, the agricultural implement 12 may generally include a frame 28 configured to be towed by the work vehicle 10 via a pull hitch or tow bar 30 in the direction of travel 14. In general, the frame 28 may include a plurality of structural frame members 32, such as beams, bars, and/or the like, configured to support or couple to a plurality of components. As such, the frame 28 may be configured to support a plurality of ground-engaging and/or ground-penetrating tools, such as a plurality of shanks, disk blades, leveling blades, basket assemblies, tines, spikes, and/or the like. In one embodiment, the various ground-engaging and/or ground-penetrating tools may be configured to perform a tillage operation or any other suitable ground-engaging operation on the field across which the agricultural implement 12 is being towed. For example, in the illustrated embodiment, the frame 28 is configured to support various gangs 34 of disk blades 36, a plurality of ground-penetrating shanks 38, a plurality of leveling blades 40, and a plurality of crumbler wheels or basket assemblies 42. However, in alternative embodiments, the frame 28 may be configured to support any other suitable ground-engaging tool(s), ground-penetrating tool(s), or combinations of such tools.

Moreover, a location sensor 102 may be provided in operative association with the work vehicle 10 and/or the agricultural implement 12. For instance, as shown in FIG. 1, the location sensor 102 is installed on or within the work vehicle 10. However, in other embodiments, the location sensor 102 may be installed on or within the agricultural implement 12. In general, the location sensor 102 may be configured to determine the current location of the work vehicle 10 and/or the agricultural implement 12 using a satellite navigation positioning system (e.g., a GPS system, a Galileo positioning system, the Global Navigation satellite system (GLONASS), the BeiDou Satellite Navigation and Positioning system, and/or the like). In such an embodiment, the location determined by the location sensor 102 may be transmitted to a computing system of the work vehicle 10 and/or the agricultural implement 12 (e.g., in the form coordinates) and stored within the computing system's memory for subsequent processing and/or analysis. For instance, based on the known dimensional configuration and/or relative positioning between the work vehicle 10 and the agricultural implement 12, the determined location from the location sensor 102 may be used to geo-locate the agricultural implement 12 within the field.

Furthermore, a soil sensor 104 may be provided in operative association with the work vehicle 10 and/or the agricultural implement 12. In general, the soil sensor 104 may be configured to capture data indicative of a subsurface soil compaction layer present within the field as the vehicle/implement 10/12 travels across the field. As will be described below, the data captured by the soil sensor 104 may be used to identify the position the bottom surface of the compaction layer. In this respect, the soil sensor 104 may be a non-contact-based sensor installed or otherwise supported on the work vehicle 10 and/or the agricultural implement 12 such that the sensor 104 has a field of view or sensor detection range directed towards a portion of the field adjacent to the vehicle/implement 10/12. For example, as shown in FIG. 1, in one embodiment, the soil sensor 104 may be mounted on a forward end 44 of the work vehicle 10 to capture data associated with a portion of the soil within the field disposed in front of the vehicle 10 relative to the direction of travel 14. However, in alternative embodiments, the soil sensor 104 may be installed at any other suitable location on the work vehicle 10 and/or the agricultural implement 12. Additionally, in some embodiments, the vehicle/implement 10/12 may include more than one soil sensor 104.

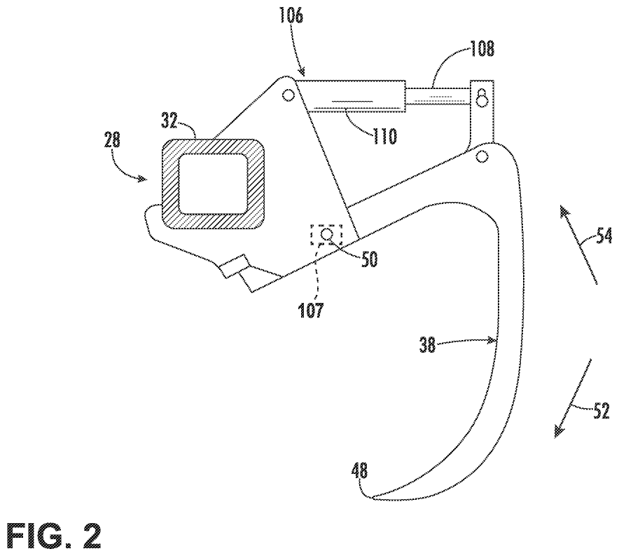

Referring now to FIG. 2, a side view of one embodiment of one of the shanks 38 of the agricultural implement 12 described above with reference to FIG. 1 is illustrated in accordance with aspects of the present subject matter. As indicated above, the shanks 38 may be configured to till or otherwise cultivate the soil. In this regard, one end of each shank 38 may include a tip 48 configured to penetrate the soil within the field to a penetration depth as the implement 12 is pulled across the field. The opposed end of each shank 38 may be pivotally coupled to the implement frame 28, such as at pivot point 50. As such, each shank 38 may be configured to pivot relative to the frame 28 in a manner that adjusts its penetration depth. In one embodiment, the various shanks 38 of the implement 12 may be configured as rippers. However, in alternative embodiments, the shanks 38 may be configured as chisels, sweeps, tines, or any other suitable type of shanks. Furthermore, the other shanks coupled to the frame 28 may have the same or a similar configuration to as the shank 38 shown in FIG. 2.

In several embodiments, the agricultural implement 12 includes one or more ground-penetrating tool actuators 106, with each actuator 106 coupled between the frame 28 and one of the shanks 38. In general, each actuator 106 may be configured to move or otherwise adjust the orientation or position of the corresponding shank 38 relative to the implement frame 28 in a manner that adjusts the penetration depth of the shank 38. More specifically, as shown in the illustrated embodiment, a first end of each actuator 106 (e.g., a rod 108 of each actuator 106) is coupled to the corresponding shank 38, while a second end of each actuator 106 (e.g., a cylinder 110 of each actuator 106) is coupled to the frame 28. As such, the rod 108 of each actuator 106 may be configured to extend relative to the corresponding cylinder 110 to pivot the corresponding shank 38 relative to the frame 28 in a first pivot direction (indicated by arrow 52), thereby increasing the penetration depth of the shank 38. Conversely, the rod 108 of each actuator 106 may be configured to retract relative to the corresponding cylinder 110 to pivot the corresponding shank 38 relative to the frame 28 in a second pivot direction (indicated by arrow 54), thereby decreasing the penetration depth of the shank 38. In the illustrated embodiment, each actuator 106 corresponds to a fluid-driven actuator, such as a hydraulic or pneumatic cylinder. However, in alternative embodiments, each actuator 106 may correspond to any other suitable type of actuator, such as an electric linear actuator.

Moreover, in several embodiments, the agricultural implement 12 includes one or more force sensors 107, with each force sensor 107 being in operative association with one of the shanks 38. In general, each force sensor 107 is configured to generate data indicative of the force or load being applied to the corresponding shank 38 by the soil within the field. As will be described below, the data generated by the force sensor(s) 107 is used to calibrate the soil sensor 104. In some embodiments, each force sensor 107 may correspond to a load cell or a strain gauge in operative association with the pivot point 50 of the corresponding shank 38. However, in alternative embodiments, each force sensor 107 may correspond to any suitable type of force/load sensing device and/or may be positioned at any other suitable location. For example, in one alternative embodiment, each force sensor 107 may correspond to a pressure sensor configured to generate data indicative of the fluid pressure within the actuator 106, with such fluid pressure being associated with the force being applied to the corresponding shank 38 by the soil.

It should be appreciated that the configuration of the work vehicle 10 and the agricultural implement 12 described above and shown in FIGS. 1 and 2 is provided only to place the present subject matter in an exemplary field of use. Thus, it should be appreciated that the present subject matter may be readily adaptable to any manner of agricultural machine configuration.

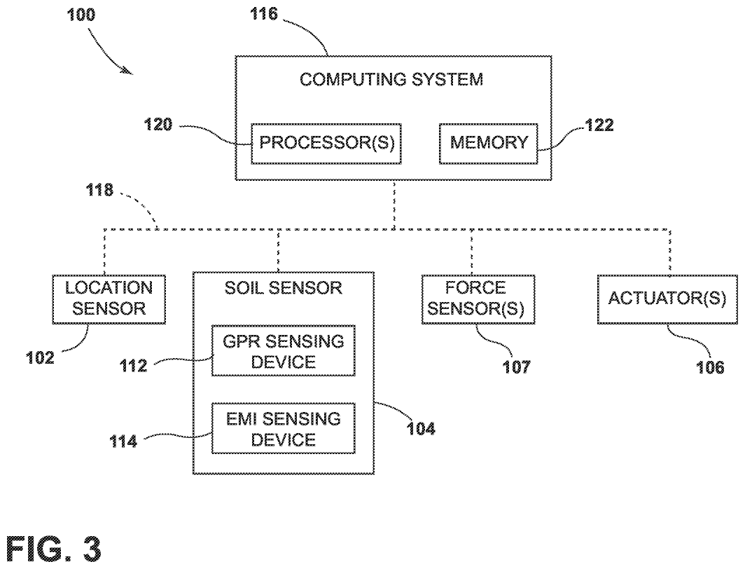

Referring now to FIG. 3, a schematic view of one embodiment of a system 100 for determining soil compaction layer location during agricultural implement operation is illustrated in accordance with aspects of the present subject matter. In general, the system 100 will be described herein with reference to the work vehicle 10 and the agricultural implement 12 described above with reference to FIGS. 1 and 2. However, it should be appreciated by those of ordinary skill in the art that the disclosed system 100 may generally be utilized with work vehicles having any other suitable vehicle configuration and/or agricultural implements having any other suitable implement configuration.

As shown in FIG. 3, the system 100 may include a soil sensor 104 provided in operative association with the vehicle 10 and/or the implement 12. In general, as mentioned above, the soil sensor 104 may be configured to capture data indicative of a subsurface soil compaction layer present within the field as the vehicle/implement 10/12 travels across the field. As such, in several embodiments, the soil sensor 104 may include a ground-penetrating radar (GPR) sensing device 112 and electromagnetic induction (EMI) sensing device 114. In such embodiments, the GPR sensing device 112 may be configured to capture GPR data associated with the soil present within the field of view or sensor detection range of the GPR sensing device 112. Similarly, the EMI sensing device 114 may be configured to capture EMI data associated with the soil present within the field of view or sensor detection range of the EMI sensing device 114. In this respect, the combination of GPR and EMI data may allow a three-dimensional representation of the soil to be generated (that could not be generated by GPR or EMI data alone). As will be described below, such three-dimensional representation may, in turn, allow the position of the bottom surface of the compaction layer within the soil to be identified.

The GPR sensing device 112 may correspond to any suitable sensor or sensing device configured to capture data associated with the soil within the field using radio waves. For example, the GPR sensing device 112 may be configured to emit one or more radio wave output signals directed toward a portion of the soil within its field of view or sensor detection zone. A portion of the output signal(s) may, in turn, be reflected by the subsurface compaction layer as echo signal(s). Moreover, the GPR sensing device 112 may be configured to receive the reflected echo signal(s). In this regard, the time of flight, amplitude, frequency, and/or phase of the received echo signal(s) may be used to generate the three-dimensional representation (in combination with the EMI data) and/or determine the one or more parameters associated within the compaction (e.g., density).

Moreover, the EMI sensing device 114 may correspond to any suitable sensor or sensing device configured to capture data associated with the soil within the field using electromagnetic induction. For example, the EMI sensing device 114 may include a coil(s) or other inductor(s). In this respect, as the vehicle/implement 10/12 travels across the field, the EMI may induce a current within the soil. The current may, in turn, vary with the parameters of the compaction layer (e.g., position of the bottom surface, thickness, density, and/or the like). As such, the induced current may be used to generate the three-dimensional representation (in combination with the GPR data) and/or determine the one or more parameters associated within the compaction.

However, in alternative embodiments, the soil sensor 104 may be configured as any other suitable sensor(s) or sensing device(s) configured to capture data that can be used to identify the position of the bottom surface of the compaction layer as the vehicle/implement 10/12 travels across the field. For example, in one embodiment, the soil sensor 104 may be a contact-based sensor, such as a cone penetrometer.

Moreover, the system 100 may include a computing system 116 communicatively coupled to one or more components of the work vehicle 10, the agricultural implement 12, and/or the system 100 to allow the operation of such components to be electronically or automatically controlled by the computing system 116. For instance, the computing system 116 may be communicatively coupled to the location sensor 102 via a communicative link 118. As such, the computing system 116 may be configured to receive data from the location sensor 102 that is indicative of the location of the vehicle/implement 10/12 within the field. Additionally, the computing system 116 may be communicatively coupled to the soil sensor 104 via the communicative link 118. As such, the computing system 116 may be configured to receive data from the soil sensor 104 that is indicative of the location of the compaction layer within the field as the vehicle/implement 10/12 travels across the field. Furthermore, the computing system 116 may be communicatively coupled to the force sensor(s) 107 via the communicative link 118. In this respect, the computing system 116 may be configured to receive data from the force sensor(s) 107 that is indicative of the force(s) being applied to the ground-penetrating tool(s) (e.g., the shanks(s) 38) of the implement 12 by the soil as the vehicle/implement 10/12 travels across the field. In addition, the computing system 116 may be communicatively coupled to the ground-penetrating tool actuator(s) 106 via the communicative link 118. In this respect, the computing system 116 may be configured to control the operation of the ground-penetrating tool actuator(s) 106 in a manner that controls the penetration depth(s) of the associated ground-penetrating tool(s) (e.g., the shanks 38). Additionally, the computing system 116 may be communicatively coupled to any other suitable components of the vehicle 10, the implement 12, and/or the system 100.

In general, the computing system 116 may comprise one or more processor-based devices, such as a given controller or computing device or any suitable combination of controllers or computing devices. Thus, in several embodiments, the computing system 116 may include one or more processor(s) 120 and associated memory device(s) 122 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 122 of the computing system 116 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 122 may generally be configured to store suitable computer-readable instructions that, when implemented by the processor(s) 120, configure the computing system 116 to perform various computer-implemented functions, such as one or more aspects of the methods and algorithms that will be described herein. In addition, the computing system 116 may also include various other suitable components, such as a communications circuit or module, one or more input/output channels, a data/control bus and/or the like.

The various functions of the computing system 116 may be performed by a single processor-based device or may be distributed across any number of processor-based devices, in which instance such devices may be considered to form part of the computing system 116. For instance, the functions of the computing system 116 may be distributed across multiple application-specific controllers or computing devices, such as a vehicle controller, an implement controller, a navigation controller, and/or the like.

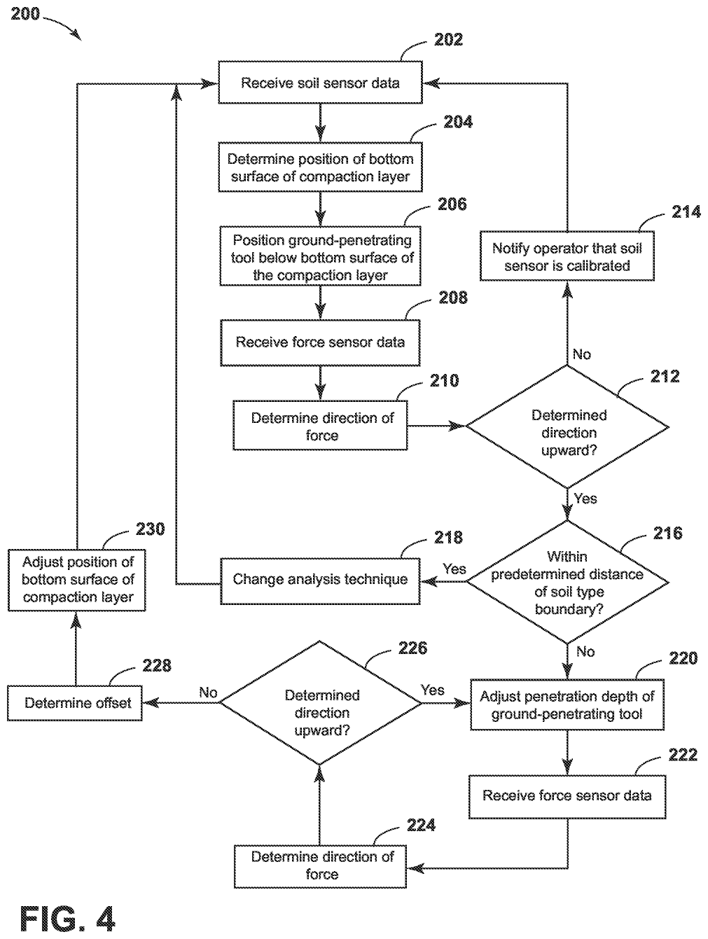

Referring now to FIG. 4, a flow diagram of one embodiment of control logic 200 that may be executed by the computing system 116 (or any other suitable computing system) for determining soil compaction layer location during agricultural implement operation is illustrated in accordance with aspects of the present subject matter. Specifically, the control logic 200 shown in FIG. 4 is representative of steps of one embodiment of an algorithm that can be executed to determine the location of the soil compaction layer with improved accuracy. Thus, in several embodiments, the control logic 200 may be advantageously utilized in association with a system installed on or forming part of an agricultural implement and/or a work vehicle to allow for real-time soil compaction layer location determination during agricultural implement operation without requiring substantial computing resources and/or processing time. However, in other embodiments, the control logic 200 may be used in association with any other suitable system, application, and/or the like for determining soil compaction layer location during agricultural implement operation.

As shown, at (202), the control logic 200 includes receiving soil sensor data indicative of the location of a compaction layer within a field. Specifically, as mentioned above, in several embodiments, the computing system 116 may be communicatively coupled to the soil sensor 104 via the communicative link 118. In this respect, as the vehicle/implement 10/12 travels across the field to perform an agricultural operation (e.g., a tillage operation) thereon, the computing system 116 may receive data from the soil sensor 104. Such data may, in turn, be indicative of the location of the compaction layer within the field.

Furthermore, at (204), the control logic 200 includes analyzing the received soil sensor data to determine the position of the bottom surface of the compaction layer. Specifically, in several embodiments, the computing system 116 may analyze the soil sensor data received at (202) to determine the position of the bottom surface of the soil compaction layer (e.g., the depth or distance of the bottom surface of the compaction layer below the top surface of the field in the vertical direction) at the location of the implement 12. For example, the computing system 116 may include a suitable algorithm(s) stored within its memory device(s) 122 that, when executed by the processor 120, analyzes the received soil sensor data to determine the position of the bottom surface of the compaction layer in accordance with moisture levels, pressure limits, or energy dissipation.

As mentioned above, in some embodiments, the soil sensor 104 may include the GPR sensing device 112 and the EMI sensing device 114 such that, at (202), the computing system 116 may receive a combination of GPR and EMI data. In such embodiments, at (204), the computing system 116 may be configured to generate representation of the portion of the soil within the field at the current location of the agricultural implement 12 based on the data received from the soil sensor 104 (e.g., the GPR data captured by the GPR sensing device 112 and the EMI data captured by the EMI sensing device 114). Thereafter, the computing system 116 may analyze the generated representation of the soil to determine the position of the bottom surface of the compaction layer. As such, the computing system 116 may include a suitable algorithm(s) stored within its memory device(s) 122 that, when executed by the processor 120, allows the position of the bottom surface of the compaction layer to be identified from the representation of the soil.

The representation of the portion of the soil within the field may correspond to any suitable data structure depicts or otherwise provides an indication of the soil structure adjacent to the field surface based on the received soil sensor data. For example, in several embodiments, the representation of the soil may correspond to a two-dimensional or three-dimensional image(s) or spatial model illustrating or depicting one or more subsurface soil layers. In this respect, the generated three-dimensional representation may provide an indication of various parameters associated with a subsurface soil compaction layer present within the field across which the vehicle/implement 10/12 is traveling. For example, such parameters may include the position or depth of the bottom and/or top surface of the compaction layer relative to the top surface of the field, the thickness of the compaction layer, and/or the like. However, in alternative embodiments, the three-dimensional representation of the soil may correspond to any other suitable type of data structure, such as one-dimensional representation or dataset.

Additionally, at (206), the control logic 200 includes controlling the operation of an actuator of an agricultural implement such that a tip of a ground-penetrating tool of the implement is positioned at an initial penetration depth below the determined bottom surface of the compaction layer. Specifically, in several embodiments, the computing system 116 is configured to control the operation of the ground-penetrating tool actuator(s) 106 such that the tips 48 of the shanks 38 are positioned at an initial penetration depth below the location of the bottom surface of the compaction layer determined at (204) in the vertical direction. For example, the computing system 116 may transmit control signals to the ground-penetrating tool actuators 106 via the communicative link 118. Such control signals may, in turn, instruct the actuators 106 to adjust the positions of the shanks 38 such that the tips 48 are positioned below the bottom surface of the compaction layer as determined based on the soil sensor data.

Moreover, at (208), the control logic 200 includes receiving force sensor data indicative of the force being applied to the ground-penetrating tool by the soil. Specifically, as mentioned above, in several embodiments, the computing system 116 may be communicatively coupled to the force sensor(s) 107 via the communicative link 118. In this respect, as the vehicle/implement 10/12 travels across the field to perform the agricultural operation, the computing system 116 may receive data from the force sensor(s) 107. Such data may, in turn, be indicative of the force being applied to the shanks 38 by the soil.

In addition, at (210), the control logic 200 includes determining the direction of the force being applied to the ground-penetrating tool based on the received force sensor data. Specifically, in several embodiments, the computing system 116 may analyze the force sensor data received at (208) to determine the direction of the forces being applied to the shanks 38 by the soil within the field. For example, the computing system 116 may include a look-up(s) stored within its memory device(s) 122 that correlates the received force sensor data to the directions of the forces being applied to the shanks 38. As will be described below, the determined direction of the force(s) being applied to the ground-penetrating tool(s) of the agricultural implement 12 is used to calibrate the soil sensor 104.

As shown in FIG. 4, at (212), the control logic 200 includes determining when the direction of the force being applied to the ground-penetrating tool is upward in the vertical direction. Specifically, in several embodiments, the computing system 116 is configured to determine when the direction of the force determined at (210) is upward in the vertical direction. For example, when the tips 48 of the shanks 38 are positioned below the bottom surface of the compaction layer, a downward force is exerted on the shanks 38. In this respect, when the determined direction of the forces being applied to the shanks 38 is downward and not upward, the soil sensor 104 is properly calibrated. That is, the position of the bottom surface of the compaction as determined by the data received from the soil sensor 104 is correct when determined direction of the forces being applied to the shanks 38 is not upward. In such instances, the control logic 200 proceeds to (214). Conversely, when the tips 48 of the shanks 38 are not positioned below the bottom surface of the compaction layer, an upward force is exerted on the shanks 38. In this respect, when the determined direction of the forces being applied to the shanks 38 is upward, the soil sensor 104 is not properly calibrated. That is, the position of the bottom surface of the compaction layer as determined by the data received from the soil sensor 104 is incorrect when the determined direction of the forces being applied to the shanks 38 is upward. In such instances, the control logic 200 proceeds to (216) and, as will be described below, the computing system 116 adjusts one or more parameters associated with determining the location of the compaction layer.

At (214), the control logic 200 includes initiating notification of the operator of the agricultural implement 12 that the soil sensor 104 is properly calibrated. Specifically, in several embodiments, when the determined direction of the forces being applied to the shanks 38 is downward and not upward, the computing system 116 may transmit feedback signals to a user interface (not shown) associated with the implement 12 (e.g., a user interface positioned within the cab 22 of the work vehicle 10). The feedback signals, in turn, instruct the user interface to provide a notification (e.g., a visual or audible notification) to the operator of the vehicle/implement 10/12 that the soil sensor 104 is properly calibrated. Upon completion of (214), the control logic 200 returns to (202).

Conversely, at (216), the control logic 200 includes determining when the agricultural implement is positioned within a predetermined distance of a soil type boundary. Specifically, in several embodiments, the computing system 116 is configured to determine when the agricultural implement 12 is positioned within a predetermined distance of a soil type boundary. The soil type boundary, in turn, is the boundary or edge between different soil types (e.g., between sandy soil and loamy soil). For example, in some embodiments, the computing system 116 may geo-locate the agricultural implement 12 within the field based on data received from the location sensor 102. Thereafter, the computing system 116 access a soil type map (e.g., stored within is memory device(s) 122) and determine whether the geo-located position of the agricultural implement 12 is within the predetermined distance of a soil type boundary. When the agricultural implement 12 is within a predetermined distance of a soil type boundary, the control logic 200 proceeds to (218). Conversely, when the agricultural implement 12 is not within the predetermined distance of a soil type boundary, the control logic 200 proceeds to (220).

At (218), the control logic 200 includes adjusting the analysis technique being used when analyzing the data generated by the soil sensor. Specifically, the particular technique or algorithm being used to analyze the soil sensor data at (204) to determine the location of the bottom surface of the compaction layer may vary depending on the type of soil. For example, certain analysis techniques may provide accurate determinations of the location of the bottom surface of the compaction layer in some soil types, but not in other soil types. For example, different soil textures dissipate or transmit energy differently (e.g., sandy soils with large textures dissipate energy slowly, while clay soils with small/denser textures dissipate energy more quickly). This, in turn, could result in falsely predicted soil compaction layers when the wrong algorithm is used for the corresponding soil texture. Thus, when it is determined that the agricultural implement 12 is within the predetermined distance of a soil type boundary at (216), the accuracy of the determinations of the location of the bottom surface of the compaction layer may be improved by changing analysis techniques/algorithms. As such, at (218), the computing system 116 is configured to adjust or otherwise change the technique or algorithm being used to analyze the soil sensor data to determine the location of the bottom surface of the compaction layer. Upon completion of (218), the control logic 200 returns to (202).

Conversely, at (220), the control logic 200 includes controlling the operation of the actuator such that the penetration depth of the tip of the ground-penetrating tool is adjusted from the initial penetration depth to a calibrated penetration depth. Specifically, when it is determined that the agricultural implement 12 is not within the predetermined distance of a soil type boundary at (216), the accuracy of the determinations of the location of the bottom surface of the compaction layer is unlikely to be improved by changing analysis techniques. Thus, in such instances, the computing system 116 may be configured to control the operation of the ground-penetrating tool actuator(s) 106 such that the tips 48 of the shanks 38 are adjusted from the initial penetration depth set at (206) to a calibrated penetration depth. For example, the computing system 116 may transmit control signals to the ground-penetrating tool actuator(s) 106 via the communicative link 118. Such control signals may, in turn, instruct the actuator(s) 106 to adjust the positions of the shanks 38 until the force profile on the shanks 38 becomes downward, thereby indicating the correct calibrated position.

Furthermore, at (222), the control logic 200 includes receiving force sensor data indicative of the force being applied to the ground-penetrating tool by the soil. Specifically, in several embodiments, after the tips 48 of the shanks 38 are adjusted to the calibrated penetration depth, the computing system 116 may receive data from the force sensor(s) 107. Such data is, in turn, indicative of the forces being applied to the shanks 38 by the soil.

Additionally, at (224), the control logic 200 includes determining the direction of the force being applied to the ground-penetrating tool based on the received force sensor data. Specifically, in several embodiments, after the tips 48 of the shanks 38 are adjusted to the calibrated penetration depth, the computing system 116 may analyze the force sensor data received at (222) to determine the direction of the forces being applied to the shanks 38 by the soil within the field.

Moreover, at (226), the control logic 200 includes determining when the direction of the force being applied to the ground-penetrating tool is upward in the vertical direction. Specifically, in several embodiments, after the tips 48 of the shanks 38 are adjusted to the calibrated penetration depth, the computing system 116 is configured to determine when the direction of the force determined at (224) is upward in the vertical direction. As mentioned above, when the tips 48 of the shanks 38 are positioned below the bottom surface of the compaction layer, a downward force is exerted on the shanks 38. In this respect, when the determined direction of the forces being applied to the shanks 38 at (224) is downward and not upward, the calibrated penetration depth is below the bottom surface of the compaction layer in the vertical direction. In such instances, the control logic 200 proceeds to (228). Conversely, as mentioned above, when the tips 48 of the shanks 38 are not positioned below the bottom surface of the compaction layer, an upward force is exerted on the shanks 38. As such, when the determined direction of the forces being applied to the shanks 38 is upward, the calibrated penetration depth is still above the bottom surface of the compaction layer in the vertical direction. In such instances, the control logic 200 returns to (220) for further adjustment of the penetration depth of the shanks 38.

In addition, at (228), the control logic 200 includes determining an offset between the calibrated penetration depth of the ground-penetrating tool and the initial penetration depth of the ground-engaging tool. Specifically, in several embodiments, when it is determined that the direction of the forces being applied to the shanks 38 is downward or not upward in the vertical direction at (226), the computing system 116 is configured to determine an offset or vertical distance between the calibrated penetration depth of the shanks 38 and the initial penetration depth of the shanks 38.

Furthermore, at (230), the control logic 200 includes adjusting the determined position of the bottom surface of the compaction layer by the determined offset. Specifically, in several embodiments, the computing system 116 may be configured to adjust the position of the bottom surface of the compaction layer determined at (204) by the offset determined at (228). Thus, upon completion of (228), the control logic 200 returns to (202) and the offset is applied to the position of the bottom surface of the compaction layer determined at (204). For example, when the offset is two inches and the position of the bottom surface of the compaction layer determined at (204) is at a depth of twelve inches, the tips of the shanks 38 will be positioned at a depth of fourteen inches at (206).

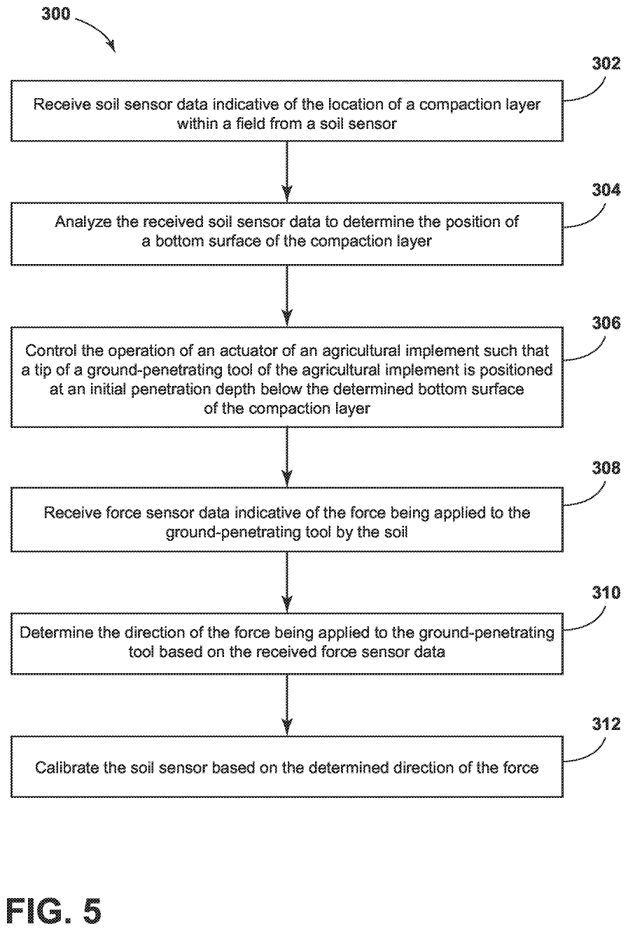

Referring now to FIG. 5, a flow diagram of one embodiment of a method 300 for determining soil compaction layer location during agricultural implement operation is illustrated in accordance with aspects of the present subject matter. In general, the method 300 will be described herein with reference to the work vehicle 10, the agricultural implement 12, and the system 100 described above with reference to FIGS. 1-4. However, it should be appreciated by those of ordinary skill in the art that the disclosed method 300 may generally be implemented with any work vehicle having any suitable vehicle configuration, with any agricultural implement having any suitable implement configuration, and/or within any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (302), the method 300 includes receiving, with a computing system, soil sensor data indicative of the location of a compaction layer within a field from a soil sensor. For instance, as described above, the computing system 116 may be configured to receive soil sensor data from the soil sensor 104. Such soil sensor data is, in turn, indicative of the location of a compaction layer within the field across which the vehicle/implement 10/12 is traveling.

Furthermore, at (304), the method 300 includes analyzing, with the computing system, the received soil sensor data to determine the position of the bottom surface of the compaction layer. For instance, as described above, the computing system 116 may be configured to analyze the received soil sensor data to determine the position of the bottom surface of the compaction layer.

Additionally, at (306), the method 300 includes controlling, with the computing system, the operation of an actuator of an agricultural implement such that a tip of a ground-penetrating tool of the agricultural implement is positioned at an initial penetration depth below the determined bottom surface of the compaction layer. For instance, as described above, the computing system 116 may be configured to control the operation of the ground-penetrating tool actuator(s) 106 of the agricultural implement 12 such that the tips 48 of the shanks 38 are positioned at an initial penetration depth below the determined bottom surface of the compaction layer.

Moreover, at (308), the method 300 includes receiving, with the computing system, force sensor data indicative of the force being applied to the ground-penetrating tool by the soil. For instance, as described above, the computing system 116 may be configured to receive force sensor data from the force sensor(s) 107. Such data is, in turn, indicative of the force(s) being applied to the shank 38 by the soil.

In addition, at (310), the method 300 includes determining, with the computing system, the direction of the force being applied to the ground-penetrating tool based on the received force sensor data. For instance, as described above, the computing system 116 may be configured to determine the direction of the force(s) being applied to the shanks 38 based on the received force sensor data.

Furthermore, at (312), the method 300 includes calibrating, with the computing system, the soil sensor based on the determined direction of the force. For instance, as described above, the computing system 116 is configured to calibrate the soil sensor 104 based on the determined direction of the force force(s) being applied to the shanks 38, such as by adjusting a parameter(s) associated with determining the location of the compaction layer.

It is to be understood that the steps of the control logic 200 and the method 300 are performed by the computing system 116 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 116 described herein, such as the control logic 200 and the method 300, is implemented in software code or instructions which are tangibly stored on a tangible computer readable medium. The computing system 116 forces the software code or instructions via a direct interface with the computer readable medium or via a wired and/or wireless network. Upon loading and executing such software code or instructions by the computing system 116, the computing system 116 may perform any of the functionality of the computing system 116 described herein, including any steps of the control logic 200 and the method 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An agricultural implement, comprising:
a frame;
a ground-penetrating tool configured to penetrate soil within a field to a penetration depth;
an actuator configured to adjust the penetration depth of the ground-penetrating tool;
a force sensor configured to generate data indicative of a force being applied to the ground-penetrating tool by the soil;
a soil sensor configured to generate data indicative of a location of a compaction layer within the field; and
a computing system communicatively coupled to the force sensor and the soil sensor, the computing system configured to:
analyze the data generated by the soil sensor to determine a position of a bottom surface of the compaction layer;
control an operation of the actuator such that a tip of the ground-penetrating tool is positioned at an initial penetration depth below the determined bottom surface of the compaction layer;
determine a direction of the force being applied to the ground-penetrating tool based on the data generated by the force sensor; and
calibrate the soil sensor based on the determined direction of the force.

2. The agricultural implement of claim 1, wherein, when calibrating the soil sensor, the computing system is configured to:
determine when the direction of the force being applied to the ground-penetrating tool is upward in a vertical direction; and
adjust a parameter associated with determining the location of the compaction layer when the direction of the force is upward in the vertical direction.

3. The agricultural implement of claim 2, wherein the parameter associated with determining the location of the compaction layer comprises at least one of the penetration depth of the ground-penetrating tool or an analysis technique being used when analyzing the data generated by the soil sensor.

4. The agricultural implement of claim 1, wherein the soil sensor comprises a non-contact-based soil sensor.

5. The agricultural implement of claim 4, wherein the soil sensor comprises a ground-penetrating radar sensing device and an electromagnetic induction sensing device.

6. A system for determining soil compaction layer location during an operation of an agricultural implement, the system comprising:
a ground-penetrating tool configured to penetrate soil within a field to a penetration depth;
an actuator configured to adjust the penetration depth of the ground-penetrating tool;
a force sensor configured to generate data indicative of a force being applied to the ground-penetrating tool by the soil;
a soil sensor configured to generate data indicative of a location of a compaction layer within the field; and
a computing system communicatively coupled to the force sensor and the soil sensor, the computing system configured to:
analyze the data generated by the soil sensor to determine a position of a bottom surface of the compaction layer;
control an operation of the actuator such that a tip of the ground-penetrating tool is positioned at an initial penetration depth below the determined bottom surface of the compaction layer;
determine a direction of the force being applied to the ground-penetrating tool based on the data generated by the force sensor; and
calibrate the soil sensor based on the determined direction of the force.

7. The system of claim 6, wherein, when calibrating the soil sensor, the computing system is configured to:
determine when the direction of the force being applied to the ground-penetrating tool is upward in a vertical direction; and
adjust a parameter associated with determining the location of the compaction layer when the direction of the force is upward in the vertical direction.

8. The system of claim 7, wherein the parameter associated with determining the location of the compaction layer comprises at least one of the penetration depth of the ground-penetrating tool or an analysis technique being used when analyzing the data generated by the soil sensor.

9. The system of claim 7, wherein, when calibrating the soil sensor, the computing system is further configured to determine when the agricultural implement is positioned within a predetermined distance from a soil type boundary within the field when the direction of the force is upward in the vertical direction.

10. The system of claim 9, wherein, when calibrating the soil sensor, the computing system is further configured to adjust an analysis technique being used when analyzing the data generated by the soil sensor when the agricultural implement is positioned within the predetermined distance from the soil type boundary.

11. The system of claim 9, wherein, when calibrating the soil sensor, the computing system is further configured to control the operation of the actuator such that the penetration depth of the tip of the ground-penetrating tool is adjusted from the initial penetration depth to a calibrated penetration depth.

12. The system of claim 11, wherein, when calibrating the soil sensor, the computing system is further configured to:
determine the direction of the force being applied to the ground-penetrating tool based on the data generated by the force sensor after the ground-penetrating tool is positioned at the calibrated penetration depth; and
determine when the direction of the force being applied to the ground-penetrating tool is upward in the vertical direction after the ground-penetrating tool is positioned at the calibrated penetration depth.

13. The system of claim 12, wherein, when calibrating the soil sensor, the computing system is further configured to:
determine an offset between the calibrated penetration depth of the ground-penetrating tool and the initial penetration depth of the ground-engaging tool when the direction of the force being applied to the ground-penetrating tool is upward in the vertical direction; and
adjust the determined position of the bottom surface of the compaction layer by the offset.

14. The system of claim 6, wherein the soil sensor comprises a non-contact-based soil sensor.

15. The system of claim 14, wherein the soil sensor comprises a ground-penetrating radar sensing device and an electromagnetic induction sensing device.

16. A method for determining soil compaction layer location during an operation of an agricultural implement, the agricultural implement including a ground-penetrating tool configured to penetrate soil within a field to a penetration depth and an actuator configured to adjust the penetration depth of the ground-penetrating tool, the method comprising:
receiving, with a computing system, soil sensor data indicative of a location of a compaction layer within the field from a soil sensor;
analyzing, with the computing system, the received soil sensor data to determine a position of a bottom surface of the compaction layer;
controlling, with the computing system, an operation of the actuator such that a tip of the ground-penetrating tool is positioned at an initial penetration depth below the determined bottom surface of the compaction layer;
receiving, with the computing system, force sensor data indicative of a force being applied to the ground-penetrating tool by the soil;
determining, with the computing system, a direction of the force being applied to the ground-penetrating tool based on the received force sensor data; and
calibrating, with the computing system, the soil sensor based on the determined direction of the force.

17. The method of claim 16, wherein calibrating the soil sensor comprises:
determining, with the computing system, when the direction of the force being applied to the ground-penetrating tool is upward in a vertical direction; and
adjusting, with the computing system, a parameter associated with determining the location of the compaction layer when the direction of the force is upward in the vertical direction.

18. The method of claim 17, wherein the parameter associated with determining the location of the compaction layer comprises at least one of the penetration depth of the ground-penetrating tool or an analysis technique being used when analyzing the data generated by the soil sensor.

19. The method of claim 17, wherein calibrating the soil sensor further comprises determining, with the computing system, when the agricultural implement is positioned within a predetermined distance from a soil type boundary within the field when the direction of the force is upward in the vertical direction.

20. The method of claim 19, wherein calibrating the soil sensor further comprises adjusting, with the computing system, an analysis technique being used when analyzing the data generated by the soil sensor when the agricultural implement is positioned within the predetermined distance from the soil type change within the field.
